(19) United States
(12) Patent Application Publication
(10) Pub. No.: US 2023/0191407 A1
(43) Pub. Date: Jun. 22, 2023

(54) METHOD FOR OPERATING AN ANALYZER, CARTRIDGE AND ANALYZER

(71) Applicant: SpinDiag GmbH, Freiburg (DE)

(72) Inventors: Frank Schwemmer, Freiburg (DE); Oliver Strohmeier, Freiburg (DE); Mark Keller, Freiburg (DE); Thomas Van Oordt, Basel (CH)

(21) Appl. No.: 18/168,709

(22) Filed: Feb. 14, 2023

Related U.S. Application Data
(63) Continuation of application No. PCT/EP2021/070376, filed on Jul. 21, 2021.

(30) Foreign Application Priority Data
Aug. 14, 2020 (DE) 10 2020 210 404.2

(51) Int. Cl. B01L 3/00; B01L 7/00

(52) U.S. Cl. CPC B01L 3/50273; B01L 7/52; B01L 2300/0803; B01L 2400/0409; B01L 2300/1805; B01L 2200/16

(57) ABSTRACT

A method for operating an analysis device for carrying out an analysis process, more particularly by using a polymerase chain reaction, includes providing a cartridge having a microfluidic channel-and-chamber structure. At least one film bag containing a process liquid is disposed in a stick-pack chamber of the cartridge. In an opening step the stick-pack chamber or stick-pack chambers are heated to a temperature of 80 to 130 degrees Celsius, and in the opening step the cartridge rotates at a rotational speed of 20 to 80 Hz. A cartridge and an analyzer are also provided.

### CROSS-REFERENCE TO RELATED APPLICATION

This application is a continuation, under 35 U.S.C. § 120, of copending International Patent Application PCT/EP2021/070376, filed Jul. 21, 2021, which designated the United States; this application also claims the priority, under 35 U.S.C. § 119, of German Patent Application DE 10 2020 210 404.2, filed Aug. 14, 2020; the prior applications are herewith incorporated by reference in their entirety.

### FIELD AND BACKGROUND OF THE INVENTION

The invention relates to a method for operating an analyzer. The invention further relates to a cartridge, especially to be used in such a method. The invention further relates to such an analyzer.

Rotation-based analysis methods are used in the medical setting with use of so-called cartridges having a channel-and-chamber structure, especially a microfluidic channel-and-chamber structure. They are usually used—besides scientific genetic material analyses and the like—for analyzing genetic material, usually in the form of DNA (deoxyribonucleic acid) or RNA (ribonucleic acid), to test for diseases present or for detecting that material to detect pathogens in any case. Starting from a sample—for example a swab, a blood sample or the like—requires multiplication of specific regions of genetic material (DNA or RNA) contained therein. When detecting or analyzing RNA in a sample (e.g., for detection of a virus), it is first transcribed into DNA by so-called “reverse transcription” and then multiplied.

In order to multiply the DNA, use is usually made of the so-called polymerase chain reaction (PCR for short) in a liquid reaction. The DNA is typically present in the form of a double-helix structure formed of two complementary single strands of DNA. In the PCR, the DNA is first separated into two single strands by an increased temperature of the liquid reaction between typically 90-96 degrees Celsius (“denaturation phase”).

Thereafter, the temperature is lowered again (“annealing phase,” typically within a range of 50-70° C.) in order to allow specific annealing of so-called primer molecules on the single strands. The primer molecules are short complementary DNA strands which attach to a defined site on the single strands of DNA. The primer molecules (also “primers” for short) serve as the starting point for an enzyme, the so-called polymerase, which, in the so-called elongation phase, fills in the building blocks (“dNTPs”) complementary to the available DNA sequence of the single strand. Starting from the primer molecule, this gives rise to a double-stranded DNA again. Elongation is typically carried out at the same temperature as in the annealing phase or at a slightly elevated temperature, typically between 65° C. and 75° C. Following elongation, the temperature is increased again for the denaturation phase.

That cycling of the temperature in the liquid reaction between the two to three temperature ranges is called “PCR thermocycling” and is typically repeated in 30 and 50 cycles. In every cycle, the specific region of DNA is multiplied. Typically, the thermocycling of the liquid reaction in a reaction vessel is realized by controlling the external temperature. The reaction vessel is, for example, present in a thermal block in which the PCR thermocycling is realized by heating and cooling of a solid body in thermal contact with the reaction vessel, and in so doing supply and dissipate heat from the liquid. Alternative heating and cooling concepts for realizing PCR thermocycling are, inter alia, controlling the temperature of fluids (especially air and water) that flow around the reaction vessel, and radiation-based concepts, for example by introducing heat by IR radiation or laser radiation. In the case of rotation-based methods, a chamber in the aforementioned cartridge is, for example, used as a reaction vessel and appropriately heated. In addition, the cartridge, which is usually approximately disk-shaped, is rotated.

### SUMMARY OF THE INVENTION

It is accordingly an object of the invention to provide a method for operating an analyzer, a cartridge, and an analyzer, which overcome the hereinafore-mentioned disadvantages of the heretofore-known methods, cartridges and analyzers of this general type and which further improve an analysis method.

This object is achieved according to the invention by a method for operating an analyzer, a cartridge, and an analyzer, as described below. Embodiments and developments of the invention that are advantageous and are in some cases in themselves inventive are stated in the dependent claims and in the following description.

With the foregoing and other objects in view there is provided, in accordance with the invention, a method for operating an analyzer, which in turn is configured and intended for carrying out an analysis process (or: analysis method), especially by using a polymerase chain reaction. According to the method, there is provided a cartridge which is especially a sample carrier and which has a microfluidic channel-and-chamber structure. At least one film bag (also referred to hereinafter as “stickpack”) containing a process liquid has been disposed in a so-called stickpack chamber (preferably correspondingly assigned to one of the possibly multiple stickpacks) of the cartridge (specifically the channel-and-chamber structure). In an opening step (of the presently described operating method), the stickpack chamber or the respective stickpack chamber (especially each containing a stickpack) is heated to a temperature of from 80 to 130 degrees Celsius. In addition, in the opening step, the cartridge is rotated at a speed of from 20 to 80 Hz.

The stickpack or the respective stickpack is therefore preferably utilized for keeping a reserve of process liquid in the cartridge for the analysis process. The stickpack has the advantage of comparatively simple handling when loading the cartridge. The latter is especially formed by a main body in which the channel-and-chamber structure is formed. After loading with the stickpack and the respective stickpack and possibly further process media which are optionally also dry, the main body is at least partially covered, i.e., closed, especially sealed by using a sealing film—preferably except for an inlet opening for the introduction of the sample material and a vent opening possibly present. The process media are, for example, dried fluorescent dyes which react with a certain material and thus allow evaluation of the analysis process by using fluorescence detection, or so-called primers or the like. Alternatively, such process media are also referred to as “analysis substances.” Dry process media are comparatively simple in their handling, since they are regularly not flowable. Furthermore, the above-described procedure in the opening step, i.e., the combination of a comparatively high temperature and a comparatively high speed, allows an advantageously rapid opening of the stickpack or the respective stickpack. This in turn saves process time.

In this case and hereinafter, the term “microfluidic” or “microfluidic channel-and-chamber structure” is especially understood to mean that the dimensions of the structure elements, preferably at least the channels, are in the range from 30 to 700 micrometers at least in one direction, especially in the depth direction or width direction. In the case of the channels, the dimensions are preferably in this order of magnitude in two directions, namely in the depth direction and width direction. Chambers can in some cases also have larger dimensions.

Preferably, a temperature of about 60° C. to 120° C., for example about 95° C., is chosen in the opening step, with a speed of at least 30 Hz, preferably about 60 Hz. As a result, the stickpack can be opened within about 5 seconds.

In a preferred method variant, the stickpack used is a bag composed of a so-called peel film. The bag has in turn a preferably heat-sealed separation seam (or else: “peel seam”). In other words, the stickpack has been thermally sealed. Therefore, a thermally assisted opening is advantageous. In this case and hereinafter, a “peel film” is understood to mean a film which has been configured and formed to make a comparatively effortless-to-separate connection with itself and/or else with other materials. Therefore, the seam strength of the separation seam is advantageously lower in any case than for a welded seam of a conventional film. The material used for the peel film is especially a polypropylene or a polyethylene.

In a further preferred method variant, the stickpack chamber or the respective stickpack chamber is subjected to localized heating. This has the advantage that sample material or additional process media are not influenced by the heating during the opening step. Furthermore, it is thus possible to minimize the energy requirement of the method.

In a convenient method variant, the volume of the stickpack chamber and the liquid volume of the respective film bag are chosen in such a way that the liquid volume in the nondisplaced state is (or: occupies) equal to or less than about a quarter of the volume of the stickpack chamber. In this case and hereinafter, “nondisplaced state” is especially understood to mean that the liquid volume of the stickpack is disposed inside the stickpack chamber and has not yet been discharged out of the stickpack chamber through a channel.

In a preferred development of the above method variant, a volume of about 1000 to 1500 microliters is used for the stickpack chamber. Consequently, about 150 to 375, preferably to about 250 microliters are used as the liquid volume of the stickpack.

Conveniently, the stickpack chamber is radially outwardly disposed in relation to the rotation axis of the cartridge (i.e., the rotation axis about which the cartridge is rotated—it must not lie within the area covered by the cartridge). Preferably, the (or the respective) stickpack chamber is offset in relation to an outer edge of the cartridge. Especially in the case of a cartridge geometry approximately corresponding to a semicircular disk, this makes it possible to arrange the comparatively large volume of the stickpack chamber with as efficient area utilization as possible. Especially since the cartridge is rotated when carrying out the analysis method, the liquid escaping from the stickpack also collects at the outward edge of the stickpack chamber due to centrifugal force. Therefore, the stickpack chamber or the respective stickpack chamber is connected to a radially inwardly offset “subsequent” chamber by using a channel radially outwardly connected to the stickpack chamber. Now, in a convenient method variant, to empty the stickpack chamber and to transfer the liquid through the radially outwardly connected channel into the subsequent chamber, the speed is lowered especially at a temperature that is constant, preferably in relation to the opening step of the stickpack. The elevated temperature for opening the stickpack increases the (chamber) internal pressure of the stickpack chamber, since the temperature causes expansion of the gas present in the stickpack chamber, for example air or else an inert gas. In addition, the vapor pressure dependent on the nature of the (stickpack) liquid and the temperature can further increase the internal pressure due to sublimating liquid. Since the subsequent chamber is, however, radially inwardly offset, the liquid “displaced” by the internal pressure in the stickpack chamber is counteracted within the channel leading to the subsequent chamber by the centrifugal force. However, if the speed is reduced, there will be a decrease in the centrifugal force and therefore in the “gravity pressure” or “centrifugal pressure” that radially outwardly forces the liquid in the channel, and so the liquid can flow through the channel into the subsequent chamber driven by the internal pressure of the stickpack chamber, even against the centrifugal force. If the internal pressure is sufficiently high, it is thus possible to achieve complete emptying of the stickpack chamber—at least virtually complete emptying, for example apart from condensation liquid. Preferably, the channel is radially inwardly connected to the subsequent chamber. What is advantageously made possible as a result—and especially also as a result of the subsequent chamber having a larger chamber volume compared to the liquid volume of the stickpack—is that the liquid transported through the channel can run off from the channel mouth. This reduces the risk that the liquid in the subsequent chamber “spatters” as a result of air flowing from the stickpack chamber. The internal pressure in the stickpack chamber is optionally controlled in a time-dependent manner, i.e., by comparatively long holding of a temperature at high speed or else by additional heating of the stickpack chamber before reduction of the speed. However, during the liquid transfer, the temperature should be kept constant in order to avoid cooling of the stickpack chamber and thus shifting of the pressure conditions.

Preferably, the speed is lowered to about 5 to 20 Hz, in particular to about 10 to 15 Hz. These speed values make it highly likely that the stickpack chamber can be completely (at least virtually) emptied as described above. Specifically, there is, however, mutual influencing of speed and internal pressure of the stickpack chamber, especially dependent on the radial position of the channel intake (i.e., at which radial position the channel is connected to the stickpack chamber) relative to the radial position of the channel mouth into the subsequent chamber. The greater the radial distance between channel intake and channel mouth, the higher the necessary (internal) pressure for transport of the liquid through the channel. However, the speed must also not be reduced as desired, since the liquid inside the stickpack chamber will otherwise not be “pushed” toward the channel intake with sufficient certainty.

What is advantageously made possible as a result of the chamber subsequent to the stickpack chamber being disposed radially inside or being connected to the stickpack chamber at least by using a channel initially running radially inwardly in a curve is that the liquid prestored in the stickpack initially remains in the stickpack chamber even after opening of the stickpack and can therefore be transferred into the subsequent chamber in a specific manner by using the above-described procedure (possibly also only at a later time).

With the objects of the invention in view, there is also provided a cartridge to be used in the method as described in greater detail herein and below. The cartridge has the microfluidic channel-and-chamber structure which has been described above and is especially at least covered, preferably apart from an inlet for introduction of sample material and an optional vent opening, and fluid-tightly sealed. The channel-and-chamber structure includes the at least one stickpack chamber. In addition, the cartridge includes the at least one stickpack which contains the above-described process liquid and which is disposed, in particular fixed, in the stickpack chamber. Preferably, the stickpack or the respective stickpack is fixed into the corresponding stickpack chamber by adhesive or fixedly held therein in some other way. In addition, the cartridge has a planar, disk-shaped structure (geometry). Preferably, the structure approximates a semicircular disk. As described above, the stickpack chamber or the respective stickpack chamber is also radially outwardly disposed in relation to a rotation axis, about which the cartridge is rotated when carrying out the method. The stickpack chamber or the respective stickpack chamber is connected by using the radially outwardly connected channel to the radially inwardly offset (“subsequent”) chamber. Alternatively, the subsequent chamber can, however, also be disposed at the same radial position or else radially further outside than the radial outward edge of the stickpack chamber. In this case, the channel connecting these two chambers describes, as described above, a radially inwardly directed curve proceeding from the channel intake of the stickpack chamber. The curve is dimensioned (especially “pulled” radially inwardly) in such a way that the liquid column in this channel prevents premature or unregulated emptying of the stickpack chamber into the subsequent chamber due to the centrifugal force, as described above.

With the objects of the invention in view, there is concomitantly provided an analyzer configured and intended for carrying out the especially rotation-based analysis process especially by using a polymerase chain reaction. To this end, the analyzer includes an accommodation device for the above-described cartridge. Preferably, the accommodation device includes an automatic feed which especially resembles a CD drive. Preferably, the accommodation device also includes a support plate on which the cartridge is placed and fixed. The support plate is preferably in the form of a rotary plate. For rotation of the cartridge (preferably specifically the rotary plate), the analyzer includes a rotary drive. Furthermore, the analyzer includes a heating device for heat input, especially localized heat input, into the cartridge. Preferably, the heating device is formed by a number of heating elements, for example resistance heating plates or Peltier elements, disposed locally on the support plate. In addition, the analyzer includes a controller configured to carry out, especially automatically, the above-described method for operating the analyzer.

Preferably, the controller is formed at least in essence by a microcontroller including a processor and a data store, in which the functionality for carrying out the method according to the invention is programmatically implemented in the form of operating software (firmware), and so the method—possibly in interaction with a user—is carried out automatically when executing the operating software in the microcontroller. In the context of the invention, the controller can alternatively, however, also be formed by a nonprogrammable electronic component, for example an ASIC, in which the functionality for carrying out the method according to the invention is implemented by circuitry.

Other features which are considered as characteristic for the invention are set forth in the appended claims.

Although the invention is illustrated and described herein as embodied in a method for operating an analyzer, a cartridge, and an analyzer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, exploded, perspective view of a cartridge for use in a rotation-based analysis method;

FIG. 2 is a top-plan view of a heat input side of a main body of the cartridge;

FIGS. 3 and 4 are respective top-plan and side-elevational views of a support plate of an analyzer, with which the cartridge is used as intended;

FIG. 5 is a view similar to FIG. 3 of the support plate with a partially assembled cartridge;

FIG. 6 is a view similar to FIG. 3 of the support plate with the cartridge in the intended use state;

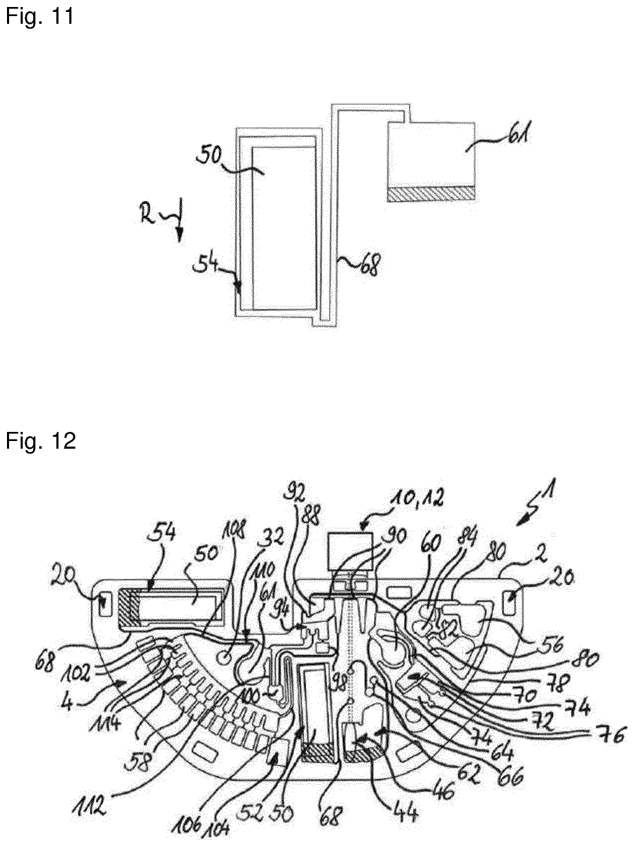

FIG. 7 is a bottom-plan view of a cover body of the cartridge;

FIGS. 8-11 are elevational views each showing a detailed illustration of two chambers of the cartridge that are connected by one channel, to illustrate substeps of the analysis method; and

FIGS. 12-19 are views similar to FIG. 2 showing the main body of the cartridge to illustrate further substeps of the analysis method.

### DETAILED DESCRIPTION OF THE INVENTION

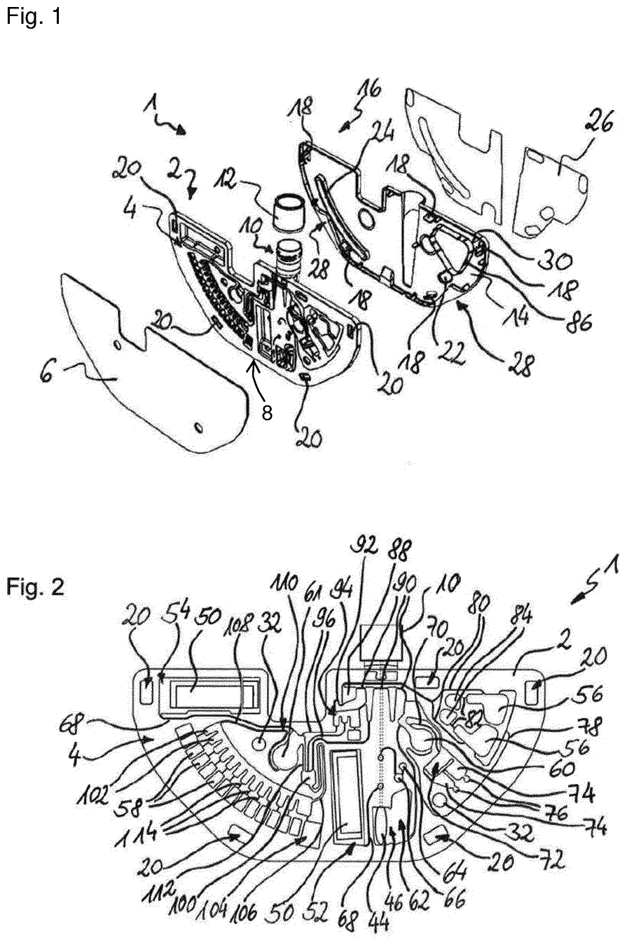

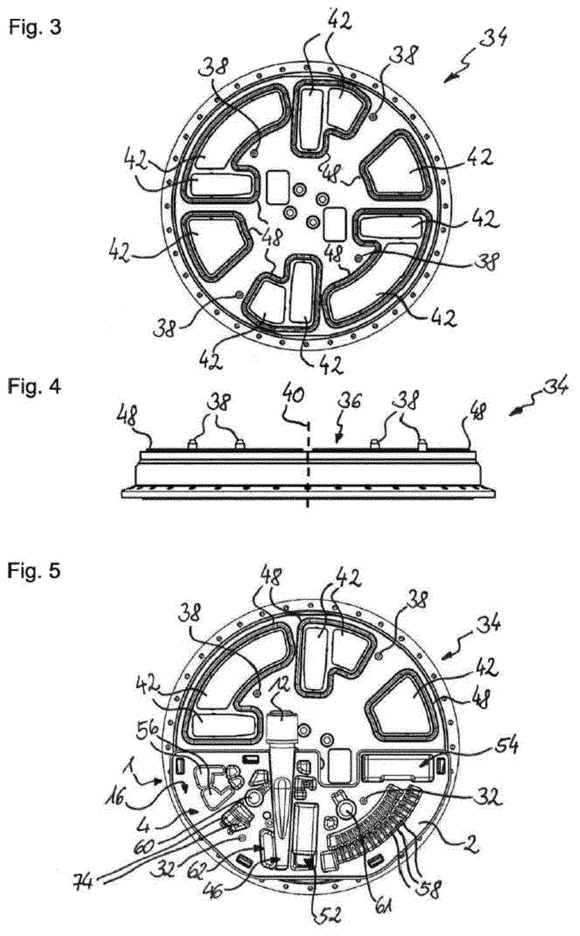

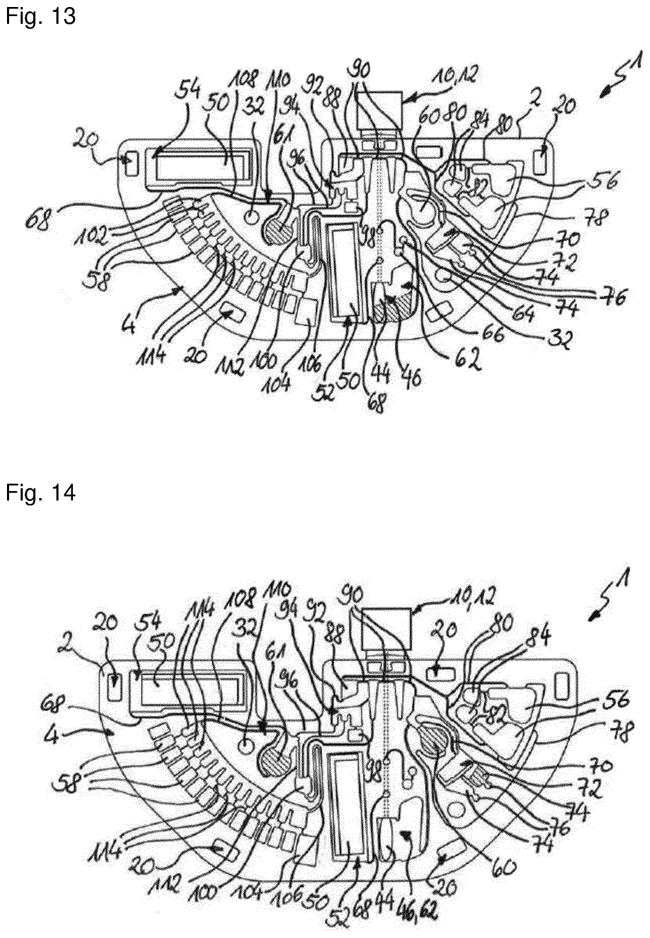

Referring now in detail to the figures of the drawings, in which parts corresponding to one another are always provided with the same reference signs, and first, particularly, to FIG. 1 thereof, there is seen a diagrammatic illustration of a sample container referred to as a “cartridge,” or else concisely as a “disk 1” due to the planar geometry approximating a halved circular disk. The disk 1 is for use in a rotation-based analysis method, which will be described in greater detail below. The disk 1 has a main body 2 (also referred to as “substrate”) which has a microfluidic channel-and-chamber structure 4. The channel-and-chamber structure 4 has in turn multiple chambers, which will be described in greater detail below and which are connected to one another by respectively assigned channels (cf. FIG. 2). In the unassembled state, the chambers and channels each form “exposed” bowl-shaped or groove-shaped indentations in the main body 2. The disk 1 therefore also has a sealing film 6 (or else: “sealing layer”) which is heat-sealed onto the microfluidic main body 2 and thus closes the channel-and-chamber structure 4 from a side referred to hereinafter as a “heat input side 8.” The main body 2 has a lateral inlet 10 to the channel-and-chamber structure 4, through which sample material can be introduced into the channel-and-chamber structure 4. The inlet 10 is reversibly closable by using a cap 12 in order to allow the introduction of the sample material and subsequent reclosure. In addition, the disk 1 has a cover body, referred to hereinafter concisely as a “cover 14,” which is placed onto the main body 2 on a “top side 16” (or else “reverse side” in relation to the heat input side 8) and fixed thereto in corresponding slots 20 of the main body 2 by using locking hooks 18 (see FIG. 7) in the present exemplary embodiment. The cover 14 has a first and a second read-out window 22 and 24, through which the contents of underlying chambers of the main body 2 can be read and thus analyzed (e.g., by using fluorescence detection) or at least monitored.

In an optional variant (depicted herein), the disk 1 also has a (in this case: two-part, preferably self-adhesive) label 26 which is applied to the cover 14. The label 26 is configured in such a way that it allows read-out through the read-out windows 22 and 24. In an optional variant, the label 26 has transparent regions which cover the read-out windows 22 and 24. Conveniently, the transparent regions are not provided with adhesive—i.e., kept free of adhesive—so that fluorescence detection is not influenced by possibly luminescent adhesive.

Laterally molded in the cover 14 in a lateral wall 30 are recesses 28 which allow alignment and positioning of the disk 1 in an automatic feed of an analyzer.

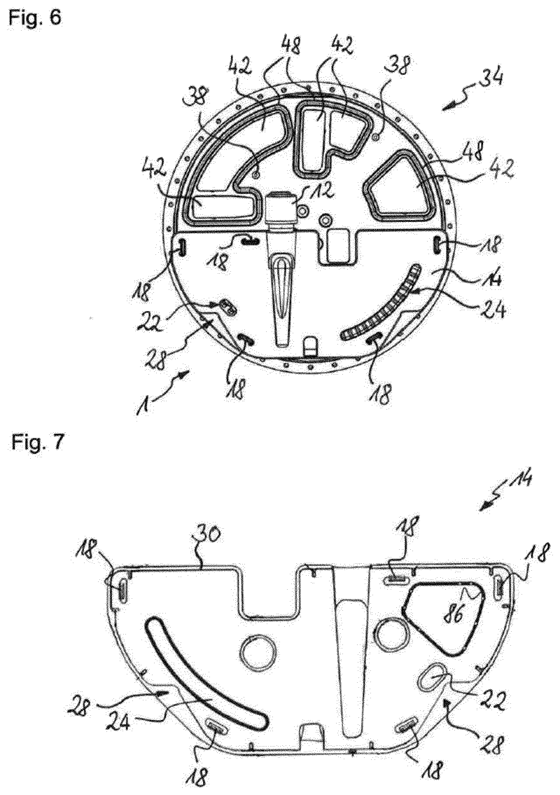

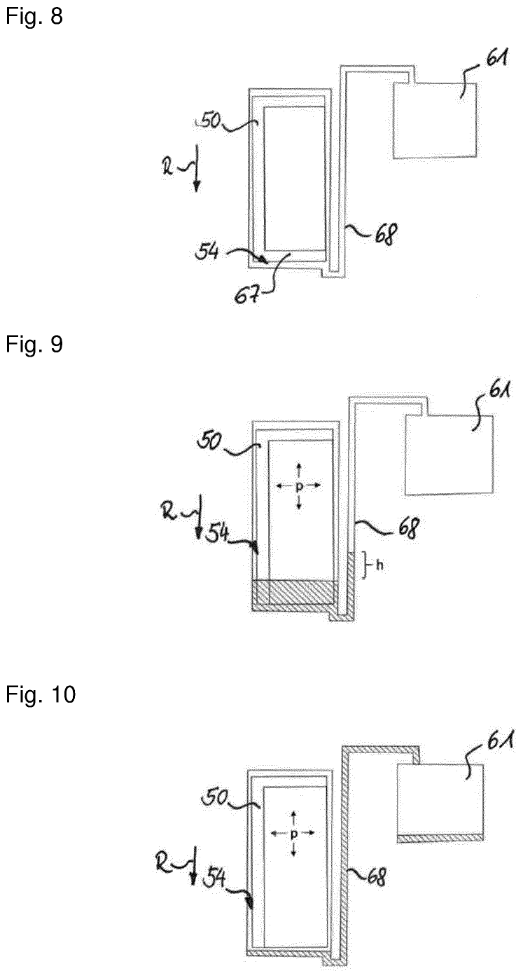

The main body 2 has multiple (in this case: specifically two) through-holes 32 which are used for clear alignment and positioning of the disk 1 on a support plate (referred to hereinafter as a “rotary plate 34,” see FIGS. 3 to 5) of the analyzer. Positioning pins 38 of the rotary plate 34 engage the through-holes 32 for positioning and fixation in a rotation plane 36 parallel to the surface of the rotary plate 34 and to the heat input side 8 (and thus to the planar extent) of the disk 1.

The rotary plate 34 of the analyzer is used for centrifugation, i.e., for rotation of the disk 1 about a rotation axis 40 (see FIG. 4). The rotary plate 34 is configured to be able to optionally accommodate two disks 1 and therefore has 180-degree rotational symmetry (see FIG. 3). In addition, the rotary plate 34 bears multiple heating elements 42 which are used for local heating of individual chambers of the channel-and-chamber structure 4 of the disk 1 and are therefore matched in terms of their outer contour to the corresponding chambers. In the present case, the heating elements 42 are formed by resistance heating plates.

In an alternative exemplary embodiment, the heating elements 42 are formed by Peltier elements, which also allow active cooling.

Individual chambers, channels and further elements of the disk 1 will be described in greater detail below on the basis of the method sequence described below.

In order to carry out the analysis method, at least one disk 1, into which a swab 44 has been inserted through the inlet 10 as sample material carrier into a swab chamber 46 of the channel-and-chamber structure 4, the inlet 10 then being closed by using the cap 12, is inserted into the analyzer and positioned and placed on the rotary plate 34. If only one disk 1 is inserted, the analyzer is configured to automatically counterbalance the rotary plate 34 (in particular by arranging counterweights on the rotary plate 34). For fixation, the disk 1 is sucked onto the rotary plate 34 by using a vacuum pump. Sealing contours 48 encircling the heating elements 34 are used for this purpose. The disk 1 is in contact therewith and can therefore be regionally sucked onto the rotary plate 34. This conveniently allows close contact between the heating elements 42 and the regions of the disk 1 to be locally heated.

In an initial state (i.e., without already introduced sample or without swap 44), the disk 1 contains prestored liquid reagents in closed stickpacks 50 in a first stickpack chamber 52 and a second stickpack chamber 54. Furthermore, so-called primers are prestored in preamplification chambers 56. Further primers and so-called probes (also referred to as “gene probes,” usually in the form of polynucleotides or oligonucleotides) are prestored in multiple read-out chambers 58. The read-out chambers 58 are visible through the read-out window 24 of the cover 14. The primer pairs in the preamplification chambers 56 are—depending on the specific goal of the analysis method and/or of the specific procedure—identical or different. For example, the primers in the read-out chambers 58 are pairwise identical to the primers in the preamplification chambers 56 or, for example, provided for a “nested PCR,” as known in the prior art, and therefore different.

Prestored in a first, approximately round “lyochamber 60” and a second, likewise approximately round lyochamber 61 are lyophilisates containing, for example, enzymes, polymerase, dNTPs (deoxynucleoside triphosphates), salts and/or other prestored reagents (e.g., PCR additives, nuclease inhibitors, cofactors of the enzymes concerned, etc.). In the present exemplary embodiment, the swab chamber 46 contains a lysis and measures for process control, for example spores, fungi, phages or artificially produced targets. A lysis chamber 62 connected to the swab chamber 46 contains a lysis pellet and also a magnet and a grinding medium. The latter is, for example, glass particles and/or zirconia particles. The particles are optionally coated with EDTA or it has been added in order to prevent coagulation in blood as sample material. In order to bind inhibitors, activated carbon is optionally added. This means that, in such an optional case, activated carbon is likewise prestored.

After sampling—for example by using a blood capillary as an alternative to the swab 44 (in sterile form in the medical setting)—the sample carrier, i.e., the swab 44 in the present case, is thus inserted into the disk 1, specifically into the swab chamber 46, and the inlet 10 is closed with the cap 12 (cf. FIG. 2). The cap 12 provides an air-tight seal in order to avoid the escape of any pathogens present in the sample material. In an optional exemplary embodiment, the disk 1, specifically the main body 2, has a vent hole 64, upstream of which are a filter and a condensation trap 66 (in the form of a comparatively small chamber). The latter allows moistening of the filter with condensation. In an alternative exemplary embodiment, the vent hole 64 can, however, also be omitted.

After the disk 1 has been positioned and fixed on the rotary plate 34, the lysis of the sample material is started by magnets disposed in the analyzer being driven over the disk 1. As a result, a magnetic field variable relative to a reference system of the disk 1 is generated and the magnet disposed in the lysis chamber 62 is moved. Due to the movement of the magnet, the particles of the grinding medium that are present in the lysis chamber 62 are rubbed against one another, with the result that bacteria, fungi, viruses or other analytes are disrupted.

In an optional method step, this mechanical lysis is thermally assisted by heating the lysis chamber 62 by using the relevant locally assigned heating element 42.

Meanwhile, there is rotation of the rotary plate 34 and thus also of the disk 1, with the result that comparatively large sample particles are sedimented due to centrifugation. This not only increases tolerance of biochemical inhibition, but also reduces the risk of clogging of microfluidic channels of the channel-and-chamber structure 4.

Optionally, the sample can be already multiplied in this starting step by using a polymerase chain reaction (PCR) or an isothermal method (e.g., loop-mediated isothermal amplification or LAMP for short, or recombinase polymerase amplification or RPA for short). Also conceivable is a nonspecific amplification in this starting step by using so-called whole-genome amplification, based for example on PCR or MDA (multiple displacement amplification).

In general, the sample material is, however, first homogenized as a result of the movement of the magnet and the particles, optionally assisted by convection based on a temperature gradient occurring in the lysis chamber 62 due to the optional one-sided heating. If a biochemical reaction in the lysis chamber 62 should additionally be envisaged, the reaction conditions in the lysis chamber 62 are also simultaneously kept homogeneous as a result, i.e., in particular a stable temperature distribution is established and/or a high degree of mixing of materials is achieved. This is particularly relevant to samples of very low concentration or to difficult-to-lyse samples. Shearing of DNA or RNA that is likewise possible can assist later amplification, since secondary structures are reduced as a result. Due to the mechanical action of the moved magnet and the forces applied to the sample material as a result, what can be (randomly) cut (“sheared”) are namely DNA or RNA strands. The strength of the shearing can be controlled by the duration and intensity of the mechanical action (i.e., thus the “mechanical lysis”), for example the speed of movement of the magnet. However, care has to be taken that DNA and RNA are not excessively sheared, since amplification is otherwise no longer possible.

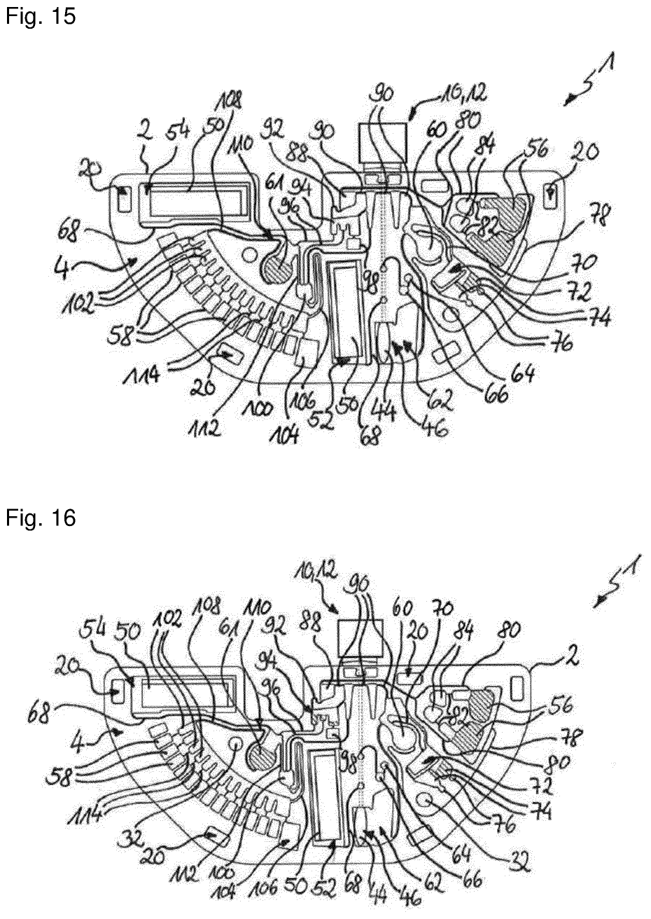

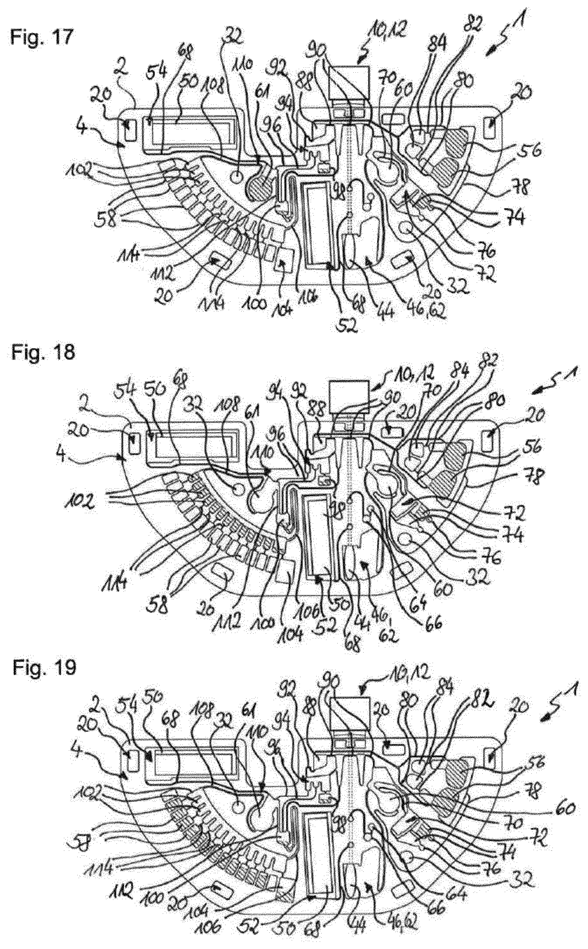

In addition, in a further method step, specifically a so-called “opening step,” the stickpack chambers 52 and 54 are heated locally to about 90° C. by using the relevant heating elements 42 and, afterwards (optionally also at the same time), the speed of the rotary plate is increased to over 30 Hz, in particular in the region of about 60 Hz. With this centrifugation at medium to high speed, the stickpacks 50 are opened within a comparatively short time of about 5 seconds due to the combination of heating and centrifugal force. Due to heating, what is thermally weakened is namely a tear seam or peel seam 67 of the stickpacks 50 formed from a so-called peel film. In FIGS. 8 and 9, this operation is diagrammatically and exemplarily depicted in greater detail for both stickpacks 50 on the basis of the stickpack chamber 54. As a result of the opening of the peel seam 67, the reserve of liquid kept in the stickpack 50 escapes into the stickpack chamber 54 (cf. also FIG. 12).

During rotation at least at 25 Hz, especially at more than 30 Hz, preferably about 60 Hz, described above, an overpressure p moreover also builds up inside the stickpack chamber 54 due to the heating of the stickpack chamber 54 (see FIG. 9). The overpressure p is caused by the expansion of the gas present in the respective stickpack chamber 52 and 54 (due to the ideal gas law) and a vapor pressure (and thus sublimation of the stickpack liquid) dependent on the liquid and the temperature in the stickpack chamber 52 and 54. Due to the overpressure p, liquid is pushed into the channel 68 leading to the lyochamber 61. Due to the continuing rotation of the disk 1, the liquid in the channel 68 is, however, counteracted by the centrifugal force acting in the radial direction R (which is perpendicular to the rotation axis 40). Depending on the speed and thus the centrifugal force, the liquid in the channel 68 can thus only rise by a “height difference” h with respect to the liquid level in the stickpack chamber 54 (see the shaded area in FIG. 9). In this state, what therefore prevails is an equilibrium between overpressure p in the stickpack chamber 54 and a centrifugal force-related “counter-pressure” in the channel 68.

With subsequent reduction of the speed, the overpressure p in the stickpack chamber 54 leads to displacement of most of the liquid (preferably more than 90%) from the stickpack chamber 54 through the channel 68 to the lyochamber 61 (cf. FIGS. 10 and 11). The displacement occurs robustly against the centrifugal forces within the disk 1 even at a centrifugation at 10 to 30 Hz. The liquid displaced from the stickpack chamber 54 dissolves a lyophilisate which is present in the lyochamber 61 and which contains portions of the reagents for later main amplification.

In accordance with the aforementioned, what also takes place is the opening of the stickpack 50 in the stickpack chamber 52 and the transfer of the liquid through the channel 68 from the stickpack chamber 52 into the swab chamber 46 and lysis chamber 62. With its radially outward edge, the lysis chamber 62 does lie approximately radially level with the stickpack chamber 52. But the channel 68 leading into the lysis chamber 62 (and into the swab chamber 46) initially runs from radially outside to radially inside in a curve, and so “direct” overflow of the liquid into the swab chamber 46 and lysis chamber 62 is prevented. The transfer of the liquid from the stickpack chamber 52 takes place before or during the above-described (mechanical) lysis in the lysis chamber 62 in order to be able to already utilize in this case the liquid of the stickpack 50 of the stickpack chamber 52.

FIG. 8 depicts the opened stickpacks 50 and, hatched in the stickpack chamber 54, the liquid which has escaped from the stickpack 50. From the stickpack chamber 52, some of the liquid has already passed over into the swab chamber 46 and the lysis chamber 62. FIG. 9 depicts the state of the stickpack chambers 52 and 54 after displacement of the respective liquid.

In a subsequent method step, the liquid (the “lysate”) is transported from the lysis chamber 62 into the subsequent lyochamber 60 (depicted in FIGS. 12 to 19 on the right above the lysis chamber 62), in which the lysate dissolves the lyophilisate prestored therein (see FIG. 14). Besides the aforementioned amplification reagents, the lyophilisate can optionally also contain nuclease inhibitors, for inactivation of specific nucleases, and further additives or cofactors such as dithiothreitol (DTT). The transport of the lysate is—again against the centrifugal force of the continuing rotation of the disk 1—driven by heating of the upstream stickpack chamber 52 and/or of the lysis chamber 62 and/or cooling of the preamplification chambers 56 subsequently fluidically connected to the lyochamber 60, of the (opposite) stickpack chamber 54 and/or of the read-out chambers 58. The cooling of the subsequent chambers causes a suction effect due to an underpressure, and the heating of the upstream chamber or chambers accordingly conversely causes forward movement of the liquid due to the overpressure.

The lyochamber 60 is connected to an overflow chamber 72 by using an overflow channel 70. During transport of the lysate from the lysis chamber 62 into the chamber 60, excess lysate flows through the overflow channel 70 into the overflow chamber 72. Connected to the overflow chamber 72 are control chambers 74 and 76, which are used to check for correct filling of the disk 1. Lysate flowing off into the overflow chamber 72 fills, from there, the control chambers 74 and the control chambers 76 (depicted schematically in FIG. 14). The filling of the control chambers 74 and 76 is used to check for correct filling of the disk 1. In particular, the filling of the control chamber 74 of roughly square geometry depicted in FIG. 10 on the right, specifically the filling of the control chamber 76 radially outwardly joined thereto, is understood to mean that there is no underfilling of the disk 1. The filling of the roughly triangular (cf. FIG. 10) control chamber 74 fluidically following, on the left, the roughly square control chamber 74, specifically the filling of the control chamber 76 radially outwardly joined thereto, is by contrast understood to mean that there is overfilling of the disk 1. The total liquid volume present in this case is composed of the volume of the sample material introduced, usually about 105 to 170 microliters, and of the stickpack 50 of the stickpack chamber 52, about 140 to 160 microliters. The filling of the relevant control chambers 74 and 76 can be monitored by a fluorescence detector through the read-out window 22 of the cover 14 at a specific moment (e.g., at the end of the entire analysis method) or else continuously during the filling of the lyochamber 60. As a result, it is possible to determine the moment at which the control chambers 74 and 76, and thus also lyochamber 60, have been filled. This in turn makes it possible to infer possible sources of error. In an optional exemplary embodiment, a dried fluorescent dye is stored in the control chambers 74 and/or 76 in order to obtain a relatively strong signal.

In a further method step, liquid is subsequently transferred from the lyochamber 60 into the preamplification chambers 56 through a transfer channel 78 by using a high speed of 40-60 Hz. Once the liquid level in the preamplification chambers 56 goes beyond a mouth of a respective outlet channel 80, there is compression of the trapped air volume in the (radially inwardly pointing) “head space” of the preamplification chambers 56 and in one downstream chamber 84 each, connected by an assigned channel 82 (see FIG. 15).

Under high centrifugation at speeds of 40-80 Hz, what takes place in the subsequent method step is preamplification in the preamplification chambers 56. The overpressure in the preamplification chambers 56 and the chambers 84 is maintained during the preamplification due to the high centrifugation. Primers prestored in the preamplification chambers 56, for example spotted with trehalose, are first dissolved. If RNA is to be detected, reverse transcription can optionally first be carried out at a constant 35-70° C. for 30 seconds to 10 minutes or to 30 minutes in order to transcribe any RNA present into DNA. However, the preamplification by using PCR occurs by local and cyclic heating and cooling of the liquid in the preamplification chambers 56 between the ranges 50-75° C. and 80-100° C. The preamplification includes 5-30 preamplification cycles. Each cycle includes heating to 80-100° C. and subsequent cooling to 50-75° C.

The (preamplification) reaction inside the preamplification chambers 56 is assisted by a high degree of convection. It is caused by the one-sided heat input into the disk 1, specifically into the preamplification chambers 56 from the heat input side 8, and the simultaneously occurring rotation. The liquid in the preamplification chamber 56 is first heated at the heat input side 8 heated by using a heating element 42 and it thus forms a heated interface. At the same time, the density of the interface decreases relative to the rest of the liquid volume. The heated liquid of the interface rises in the artificial gravity field which is caused by the rotation of the disk 1 and which is oriented in the radial direction R, first “inwardly” against the radial direction R and then transversely to the radial direction R toward the top side 16. There, the liquid cools and falls “due to gravity” along the top side 16, outwardly in the radial direction R, and then back toward the heat input side 8. What thus occurs as a result of the heat input is convection and flow along the radial direction R. Furthermore, the Coriolis forces that likewise occur lead to the formation of a tangential (i.e., perpendicular to the radial direction R in the plane direction of the disk 1) flow component, which additionally supports the mixing of the liquid. Since the convection is caused by the artificial gravity field, it is increased by faster rotation of the disk 1. The convection that occurs at high speeds thus leads to particularly effective mixing of the reaction components inside the preamplification chambers 56, and this in turn allows efficient amplification conditions.

However, one side effect is that, in the case of very high heat output on the nonheated top side 16 of the disk 1, a high temperature gradient of, for example, 10° C. (or Kelvins) can form within the liquid volume of the preamplification chamber 56 of, for example, 10 Kelvins, which may be disadvantageous. Just the cover 14, which brings about air shielding, leads to a significant reduction in the temperature gradient to about 4-5 kelvins.

For further reduction of the heat output, the cover 14 has, in a further exemplary embodiment, a frame web 86 which annularly surrounds the preamplification chambers 56 and therefore further reduces the heat output due to convection on the top side 16 (see FIGS. 1 and 7). It can optionally also be omitted. The frame web 86 is overmolded onto the cover 14, i.e., integrally connected thereto. The frame web 86 projects in the direction of the main body 2 and ends at a small distance of about 100 μm from the main body. This extended shielding of the preamplification chambers 56 by the cover 14 and the frame web 86 allows a temperature difference of about 2 kelvins inside the respective preamplification chamber 56. Comparatively strong convection therefore does occur in the respective preamplification chamber 56 due to, inter alia, the rotation. However, what is additionally also achieved is a comparatively high degree of homogeneity of the reaction temperature inside the preamplification chamber 56—at least in the static case, i.e., when holding the temperature of the heating element 42 for at least about 10 to 30 seconds or the like. In the case of the geometry described in this case and below and the parameters applied, experience has shown that static conditions already arise from about 15 seconds.

In the event too of the occurrence in the preamplification chambers 56 of a reaction which requires an interaction, for example binding of molecules to a solid phase, for example to microarrays, or a reaction in which the concentration of the respective reaction partners is usually low and mutual contact of the respective reaction partners is therefore subject to a comparatively low probability, the high degree of convection (and therefore comparatively strong mixing) and the homogeneous temperature distribution can be advantageous.

After completion of the preamplification, the speed is reduced to about 5 to 20 Hz, specifically to about 10 Hz. As a result, the compressed air volume in the head space of the preamplification chambers 56 and in the chambers 84 can expand. This leads in turn to lowering of the liquid level inside the preamplification chambers 56, by liquid which is radially within the mouth of the outlet channels 80 being at least mostly displaced by the expanding air through the outlet channels 80 into a further chamber 88. This is made possible by the outlet channels 80 having a lower fluid resistance, specifically a larger channel cross section, than the transfer channel 78 leading into the preamplification chambers 56.

The disk 1 has vent channels 90 which, inter alia, are connected to the chamber 88 and allow internal venting of the disk 1 into other chambers. Therefore, air which would be compressed by liquid flowing into the chamber 88 can escape through the vent channels 90 in the direction of the lyochamber 60.

In a subsequent method step, the speed of the disk 1 (or the rotary plate 34) is adjusted, specifically increased, to a value range of 10-20 Hz, preferably to about 15 Hz. As a result, the liquid from the chamber 88 flows through a siphon 92 into a measurement chamber 94 which has radially outwardly three “measurement fingers” or chamber projections of differing volume. The measurement fingers are filled successively, and so the specified (measurement finger) volume leads to measurement of individual subvolumes (see FIG. 16). The flow of the liquid through the channels 96 radially outwardly connecting to the measurement fingers is limited by high fluidic resistances of the channels 96, specifically by the channel dimension thereof being smaller than 200 μm in at least one spatial direction, specifically in a cross-sectional direction. The subvolume which respectively flows through the channels 96 in the subsequent step is thus substantially specified by the volume of the respective upstream measurement finger. Excess liquid volume flows to an overflow 98.

In the next method step (see FIG. 17), increasing the centrifugation, i.e., the speed, to a range between 30 and 80 Hz, specifically to about 60 Hz, drives the measured subvolumes of the liquid into the respectively subsequent chambers, i.e., into the lyochamber 61 depicted to the left of the swab chamber 46 in FIG. 17 and into a further chamber 100.

Now, present in the lyochamber 61 are a “main amplification buffer,” which was originally prestored in the stickpack 50 disposed in the stickpack chamber 54, a lyophilisate now dissolved in this liquid, which lyophilisate was prestored in the lyochamber 61, and the “preamplification product” contained in the liquid from the preamplification chambers 56, which preamplification product was supplied through the channel 96.

In a subsequent method step, the disk 1 is rotated under comparatively rapid changes of direction, each with a change rate of 5 to 40 Hz/s, preferably by about 30 Hz/s, between end values of −20 to 40 and +20 to 40 Hz. In this case, the signs indicate the different rotation directions. The components present in the lyochamber 61 are mixed due to the accelerations occurring with the changes of direction and to Euler and Coriolis forces generated as a result in the rotation system.

In parallel, the read-out chambers 58, measurement chambers 102 upstream thereof, and an overflow chamber 104 are heated by using the correspondingly assigned heating element 42. The air expanding as a result can escape into the chamber 100 through a compensation channel 106. The mixing operation is completed by ending the changes of direction and returning to a constant speed of about 20 Hz. Thereafter, the read-out chambers 58, the measurement chambers 102 and the overflow chamber 104 are cooled back down. As a result, a relative underpressure is formed in the relevant chambers 58, 102 and 104 and the fill level in a siphon channel 108 subsequently connected to the lyochamber 61 and in the compensation channel 104 connected to the chamber 100 rises depending on a ratio between centrifugal pressure and difference in air pressure. Once the liquid goes beyond the vertex 110 of the siphon channel 108, the entire liquid is driven out of the lyochamber 61 into the subsequent measurement chambers 102 (see FIG. 18). A vent channel 112 between the lyochamber 61 and the chamber 100 allows air exchange between these two chambers 61 and 100.

The liquid flows successively into the individual measurement chambers 102 and is measured as a result. Furthermore, the liquid in the measurement chambers 102 is initially retained by one centrifugal pneumatic value each in the form of one valve channel 114 each. Excess liquid flows off into the overflow chamber 104. The centrifugal pneumatic values are based on the fact that the liquid is retained in the respective valve channel 114 by the counter-pressure in the respectively subsequent read-out chamber 58 and cannot flow into the subsequent read-out chambers 58 at a speed in the medium speed range, specifically of about 15-25 Hz in this case.

In a subsequent method step, the speed is sufficiently increased, typically to over 40 Hz, for the (liquid) menisci in the respective valve channels 114 to become unstable due to the so-called “Rayleigh-Taylor instability” and for the liquid to therefore be at least mostly transferred into the corresponding read-out chamber 58 (see FIG. 19).

In a further method step, what now take place in the read-out chambers 58 are the main amplifications. To this end, the primers and probes respectively prestored in the read-out chambers 58 are dissolved. The dissolution of the primers and probes and the subsequent amplification are assisted by a high degree of convection inside the read-out chambers 58, the cause of which is as described above for the preamplification chamber 56. The reaction is read after each cycle at about 60° C. in all read-out chambers 58 by using a fluorescence detector. It detects the fluorescence in different wavelengths. Readings are made through the read-out window 24 in the cover 14. The operation therefore corresponds to a so-called “real-time PCR.” In this case, what can take place in each of the twelve read-out chambers 58 is a multiplex reaction, for example 3-plex to 10-plex. A relevant rise in signal in the fluorescence detector indicates a detected target.

So that the optical evaluation by using the fluorescence detector is not influenced or is minimally influenced, the read-out chambers 58 have radially inwardly, beyond the region looked at by using the fluorescence detector, an indentation which is not depicted in greater detail and which is used “to collect” air bubbles and hold them back from the region looked at. An air bubble disposed in the indentation would have to be comparatively greatly deformed in order to enter the region looked at. Advantageously counteracting in this case is the bubble interface, especially influenced by the present surface tension conditions.

Further optionally, the read-out window 24 which covers the read-out chambers 58 and which is transparently closed in this case is also edged by a frame web (cf. FIG. 1) comparable to the frame web 86, and so the heat output from the read-out chamber 58 can be reduced in this case as well.

As an alternative to fluorescence detection, the evaluation can also be done by a so-called melt curve analysis, for example a “high-resolution melt curve analysis” or a “rapid melt curve analysis.” This would allow even much higher multiplexing. In an optional exemplary embodiment, what is carried out in the read-out chambers 58 is a “real-time PCR” based on so-called intercalating dyes (e.g., dyes known under the brand or the name “EvaGreen,” “SYBR Green,” “BoxTo”), the resultant PCR products being detected after amplification by melt curves. In this case, up to 20 PCR products can be detected and differentiated per chamber (20-plex).

The subject matter of the invention is not restricted to the above-described exemplary embodiments. Rather, further embodiments of the invention can be derived from the above description by a person skilled in the art. In particular, the individual features of the invention described on the basis of the various exemplary embodiments and their structural variants can also be combined with one another in another way.

The following is a summary list of reference numerals and the corresponding structure used in the above description of the invention.

### LIST OF REFERENCE SIGNS

1 Disk
2 Main body
4 Channel-and-chamber structure
6 Sealing film
8 Heat input side
10 Inlet
12 Cap
14 Cover
16 Top side
18 Locking hook
20 Slot
22 Read-out window
24 Read-out window
26 Label
28 Recess
30 Lateral wall
32 Through-hole
34 Rotary plate
36 Rotation plane
38 Positioning pin
40 Rotation axis
42 Heating element
44 Swab
46 Swab chamber
48 Sealing contour
50 Stickpack
52 Stickpack chamber
54 Stickpack chamber
56 Preamplification chamber
58 Read-out chamber
60 Lyochamber
61 Lyochamber
62 Lysis chamber
64 Vent hole
66 Condensation trap
67 Peel seam
68 Channel
70 Overflow channel
72 Overflow chamber
74 Control chamber
76 Control chamber
78 Transfer channel
80 Outlet channel
82 Channel
84 Chamber
86 Frame web
88 Chamber
90 Vent channel
92 Siphon
94 Measurement chamber
96 Channel
98 Overflow
100 Chamber
102 Measurement chamber
104 Overflow chamber
106 Compensation channel
108 Siphon channel
110 Vertex
112 Vent channel
114 Valve chamber
R Rotation direction
p Overpressure
h Height difference

1. A method for operating an analyzer for carrying out an analysis process or an analysis process using a polymerase chain reaction, the method comprising the following steps:
providing a cartridge having a microfluidic channel-and-chamber structure, and placing at least one film bag containing a process liquid in at least one stickpack chamber of the cartridge;
in an opening step, heating the at least one stickpack chamber to a temperature of from 80 to 130 degrees Celsius; and
in the opening step, rotating the cartridge at a speed of from 20 to 80 Hz.

2. The method according to claim 1, which further comprises using, as the film bag, a bag composed of a peel film having a heat-sealed separation seam.

3. The method according to claim 1, which further comprises subjecting the stickpack chamber to localized heating.

4. The method according to claim 1, which further comprises choosing a volume of the stickpack chamber and a liquid volume of the film bag so that the liquid volume of the film bag in a nondisplaced state is equal to or less than about a quarter of the volume of the stickpack chamber.

5. The method according to claim 4, which further comprises setting the volume of the stickpack chamber at about 1000 to 1500 microliters.

6. The method according to claim 1, which further comprises:
locating the stickpack chamber radially outwardly of a rotation axis of the cartridge;
using a radially outwardly connected channel to connect the stickpack chamber to a radially inwardly offset chamber; and
lowering the speed of rotating the cartridge at a constant temperature in order to empty the stickpack chamber through the channel into the inwardly offset chamber.

7. The method according to claim 6, which further comprises lowering the speed of rotating the cartridge to about 5 to 20 Hz.

8. The method according to claim 6, which further comprises lowering the speed of rotating the cartridge to about 10 to 15 Hz.

9. A cartridge for an analyzer carrying out an analysis process or an analysis process using a polymerase chain reaction, the cartridge comprising:
a microfluidic channel-and-chamber structure including at least one stickpack chamber;
at least one film bag disposed in said at least one stickpack chamber and containing a process liquid;
a planar, disk-shaped cartridge structure with a rotation axis;
said at least one stickpack chamber disposed radially outwardly of said rotation axis;
a chamber disposed downstream of said at least one stickpack chamber; and
a radially outwardly connected channel forming a radially inwardly directed curve, said radially outwardly connected channel connecting said at least one stickpack chamber to said downstream chamber.

10. The cartridge according to claim 9, wherein said microfluidic channel-and-chamber structure is at least partially covered, and said at least one film bag is fixed in said at least one stickpack chamber.

11. An analyzer for carrying out an analysis process or an analysis process using a polymerase chain reaction, the analyzer comprising:
an accommodation device for a cartridge;
a rotary drive for rotation of the cartridge;
a heating device for heat input into the cartridge; and
a controller configured to carry out the method according to claim 1.

12. The analyzer according to claim 11, wherein said heating device is configured for localized heat input into the cartridge.
